(19) United States
(12) Patent Application Publication
(10) Pub. No.: US 2007/0099684 A1
(43) Pub. Date: May 3, 2007

(54) System and method for implementing an interactive storyline

(76) Inventor: Evans Butterworth, Irvine, CA (US)

Correspondence Address: DALINA LAW GROUP, P.C., 7910 IVANHOE AVE. #325, LA JOLLA, CA, 92037, US

(21) Appl. No.: 11/267,932

(22) Filed: Nov. 3, 2005

(51) Int. Cl. A63F 13/00

(52) U.S. Cl. 463/1

(57) ABSTRACT

An interactive event that allows viewers to interact with a story in a video or film environment and change the story that is told based on input provided or obtained from the audience or other sources. For instance, an interactive event is created out of a movie storyline and given alternate endings, branching storylines, dead ends, advances, and regressions in the story. The system is designed to generate an interactive event out of a feature film by inserting menu prompts or branch points throughout the storyline allowing the player to navigate through the story based on input provided. The system allows the viewers to create different stories from the same situations. The events triggered may have a random component and thereby function much less like a pre-scripted story and more like real life where the story is always changing. The interactive storyline provides a domain wherein the participant experiences actions and conflicts along with their favorite characters with the goal of navigating to the end of the movie.

This application claims priority to United States Provisional Patent Application Serial No. ______ entitled “SYSTEM AND METHOD FOR IMPLEMENTING AN INTERACTIVE STORYLINE” as filed on Nov. 3, 2004.

### BACKGROUND

1. Field of the Invention

The invention relates to the field of computer based entertainment systems. More particularly, but not by way of limitation, embodiments of the invention are directed to systems and methods for implementing an interactive storyline.

2. Description of the Related Art

Video games interfaces have a history of make using of imagery that lacks a certain element of realism. In the late 1970's and early 1980's, video games made use of rudimentary geometric shapes that had no element of realism whatsoever. Games such as Pong, Pac Man, Galaga, and others are examples of this approach. Today computer game interfaces have advanced significantly beyond the use of simple geometric shapes and make use of advanced three-dimensional imagery that gives users a vastly more realistic game playing experience. This improved realism makes use of avatars and imagery that appears to be more lifelike than it previously has been. The games Resident Evil™, Madden Football™ Series, Tomb Raider™, are examples of video games that make use of such three-dimension imagery. The avatars used in these games are configured express human emotions and actions and generally move in an apparently human way. Although realistic in appearance and basic actions these game avatars lack the elements of realism needed to give convey a sense of live action. It is very apparent for instance that a game is being played and that the game and the actions taken by the avatars are animated and not the result of actual filming. If filming of live action characters does occur, as it did in the case of Tomb Raider™, the film stays independent of the game. Other than making use of the same general characters and concepts the actions that occur in the game do not impact or affect the movie. Moreover the story as it is told through the movie has no bearing on the outcome of the game. The game and movie effectively stay independent of one another. The elements of unanimated human realism as it is portrayed through live actors are left for the movie and the game makes use of user controlled avatars. When playing a game these avatars in some cases are given an appearance that is similar to the actor, but the avatar is still controlled by the input provided by the user during game play. The user is not able to select from a series of live action events. Instead any event that occurs during game play is an animated and inherently computer controlled expression of the command issued by the user who is playing the game. The game lacks the use of live action and instead makes use of animated imagery.

Movies similarly require that users passively view the story and have no real input or ability to impact the story or the outcome of the story. DVDs provide users with the ability to select an alternative ending, but do not provide users with a way to change the outcome or actions of the actor during the film. Hence movies although typically more realistic than video games lack the interactivity associated with such games. Because of the limitations associated with the approaches stated above there is a need for an improved mechanism for implementing an interactive storyline.

### SUMMARY OF THE INVENTION

One or more embodiments of the invention are directed to systems and methods that enable the implementation an interactive storyline that allows viewers to interact with a story as in a video game while staying within the context of a pre-recorded live action event such as a video or film environment.

It is possible to implement the invention using various approaches. For instance, in one embodiment of the invention, the system is designed to generate an interactive event out of a feature film. For instance, an interactive event is created out of a movie storyline and given alternate endings, branching storylines, dead ends, advances, and regressions in story placements. Hence the movie becomes an interface for defining the constraints within which interactive feedback is obtained from an audience. The platform implemented herein, allows the audience to create different stories every time from the same situations. The events triggered may have a random component and thereby function much less like a pre-scripted story and more like real life where the story is always changing. The interactive storyline provides a free domain where the participant can influence or change the viewing experience actions and conflicts along with their favorite characters.

Systems for implementing one or more aspects of the invention are configured to take a feature length or short video program and insert menu prompts or branch points throughout the storyline thereby allowing the player to navigate through the story. These menu prompts may arise at predetermined or random intervals to provide users with significantly more interactive experience that a typical movie. The interactive event described herein is based loosely off of one main storyline with branching themes. These alternate storylines branch to either the end, skip ahead, or recede in the storyline. The user's goal is to navigate through the interactive event until the end. This scripted or non-scripted program contains directional menu screens prompting the interactivity, i.e. DVD, Internet, or other electronic devices.

For example: A 90 minute feature film provided on a DVD, illustrates every two to five minutes a prompt asking the user to choose between alternate storyline A, B, C . . . N based on decisions about the character, storyline, or theme in order to continue. Once the user chooses A, B, or C, then a video clip continues the storyline in either the correct path, an alternate storyline, advancing, or regressing in the timeline of the story.

In one embodiment of the invention the method described herein is implemented via a computer program product that is configured to execute a software program that obtain a storyline having associated video content where said storyline comprises references to a set of alternate video content. The video content is displayed in accordance with a storyline that has various branch points where a divergent path in the story can be taken. The path that is taken is based on audience input or other input obtained via varying different mechanism. In one case input is obtain by presenting a selection interface comprising a set of branch points to the audience.

The selection interface presents a series of branch points within the storyline where the branch points are associated with references to alternate video content. Hence when a certain path is chosen as determined based on audience input the associated video content is displayed. Input is obtained in one embodiment of the invention by obtaining a selection from one or more audience members that corresponds to at least one of the branch points. When a branch point is taken alternate video content is displayed from a set of alternate video content where the content is associated with different forms of input. The branch points may relate to a new or divergent storyline, a theme to be associated with the video content or alternative video content where certain paths within the storyline are associated with a particular theme and displayed only when that theme is active.

Branch points may also relate to a certain character with the storyline and be used to cause the character to take a particular path or make a particular decision. Various method for displaying the selection interface are contemplated and the video content may or may not be paused during presentation of the selection interface. In the case where input is obtain from the audience in real-time or based on pre-determined surveys or other events no pause is needed. The selection interface is generally displayed during branch points, but can also be displayed at other times such as before the interactive event beings or throughout the interactive event. The input or decisions made at branch points may be randomly decided by the system implementing one or more aspects of the invention. Branch points can continue the storyline, end the storyline, replay past events in the storyline, converge to a different storyline, skip ahead in time on the storyline and/or be dependent upon prior choice made from input received. When the audience is able to navigate through the storyline to reach a stated or unstated goal rewards may be given to the audience members.

### BRIEF DESCRIPTION OF THE DRAWINGS

FIG. 1 is a flow chart illustrating the overall concept of the interactive event based on a dynamic storyline in accordance with one or more embodiments of the invention.

FIG. 1a is a flow chart illustrating the overall concept of the interactive storyline.

FIG. 2 provides a simplified example of an interactive event based on a dynamic storyline configured in accordance within an embodiment of the invention

FIG. 2a shows choices that result in alternate storylines that immediately end, replay past events, skip ahead in time, effect availability of pathways and create new stories.

FIG. 2b shows choices that result in alternate storylines with alternative endings.

### DETAILED DESCRIPTION OF THE INVENTION

One or more embodiments of the invention are directed to a system and method for enabling an interactive event based on a dynamically storyline. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances specific features well known to those of ordinary skill in the art have not been described in detail so as not to obscure the invention. Readers should note that although examples of the invention are set forth herein, the claims, and the full scope of any equivalents, are what define the metes and bounds of the invention.

Implementing the systems and methods described herein enables the production of an interactive feature film that encompasses multiple events and outcomes the selection of which are influenced or decided by the audience. This form of entertainment allows the audience member to participate at certain decision points throughout the event in order to reach the end goal. The methodology described herein can be implemented through the use of platforms such as DVD Players, DVD-ROMs, Computers, Internet Video. Players, or any other computation device that can obtain input from the one or more audience members and display a digital or analog rendition of a film based on the input received.

In or more embodiments of the invention the interactive event takes the form of a feature length motion picture, or movie that is dynamically affected by input received from audience members and/or other events defined as influencing events. Systems are configured to contain a series of pre-recorded scenes that are arranged as per a hierarchical structure. What is displayed to the audience members and what path is taken through the hierarchical storyline depends on what input is received from the audience members. Various types of input are able to cause a change in the storyline. In some cases the audience members are presented with a set of options and asked to decide about what event, decision or emotional state the character in the movie being shown is to make or adopt next. Audience members can also select whether to view the same scene from a different perspective (e.g., camera angle) and/or decide whether to replay a particular scene, play past certain events, or skip ahead in the storyline. The choice made affect the availability or alter the pathways of future storylines.

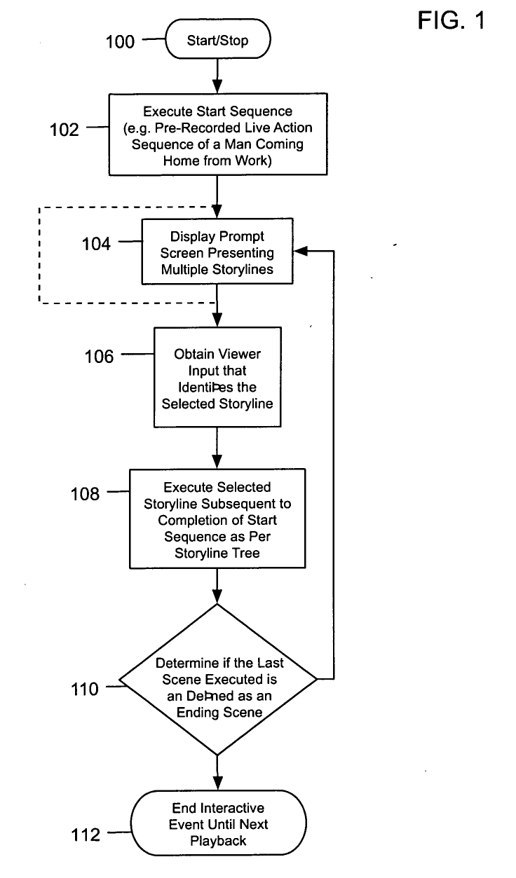

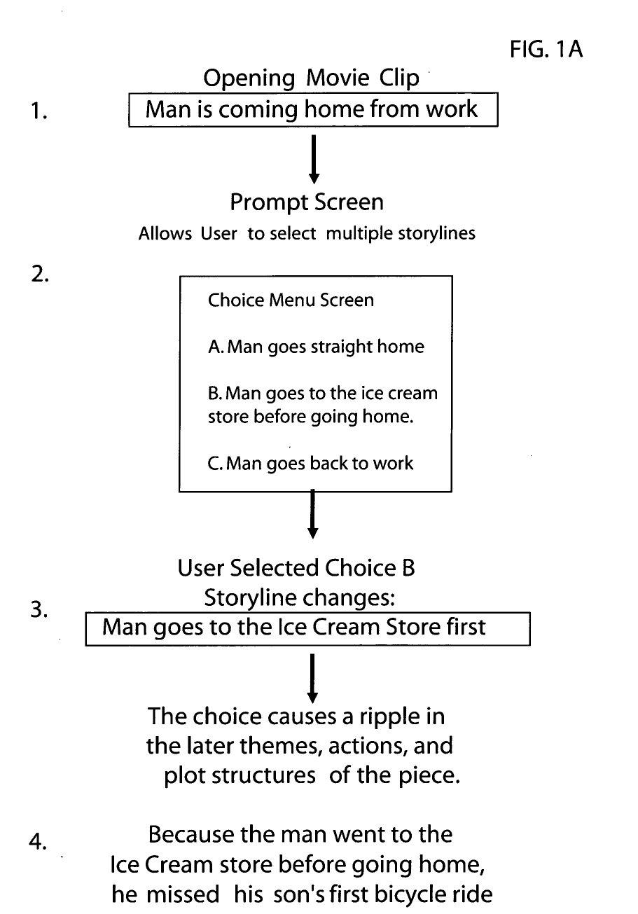

FIG. 1 illustrates a general view of the method used to practice one or more embodiments of the invention. An interactive event starts (100) by the execution of a start-sequence (102) that is the beginning point of a storyline. There can be more than one beginning, but generally the same initial start-sequence is used unless the audience or the storyline author decides otherwise. An interface for obtaining input, such as a display prompt that presents multiple diverging storylines is presented to the audience who may be made up on one or more people (104). Optionally the menu prompt may be skipped and other forms of input may be used as input to make the decision requested at step 104. Once input is obtained (106) by having it provided via step 104 or obtained from other sources as described in more detail below, the selected sequence is executed subsequent to display of the start-sequence. The opportunities for the audience to provide or for the system to obtain further input are dictated by a branching storyline hierarchy as determined by the author of the storyline or as the case may be multiple storylines where the story selected for display is dictated by input from the audience or other sources. The system will continue to iterate displaying scenes as determined by the input until an end or last scene is played (110). At that point the interactive event terminates until it is replayed again (112).

What is meant by audience input will now be elaborated upon. In one embodiment of the invention input from the audience is obtained via a menu. This menu may appear as a menu that shows the selections that can be made as to what is to happen next in the story. For instance, the movie may be interrupted by or contain overlaying prompts or menu screens that allow the viewer to change the “movie” by selecting from multiple available options. Systems embodying one or more aspects of the invention initially execute a start sequence and then present a range of storylines available that the user may choose from. In other cases the user selects the initial start sequence. When selecting an initial sequence the user may select a specific scene to view or set a general theme that is to be applicable throughout the duration of the movie or at least until an alternative theme choice is made. Some examples of the types of themes the user may select include, but are not limited to general themes such as “fast paced thriller”, “comedy”, “horror”, “love story” or any other general label that might general describe what scenes are appropriate within the context of the theme. Once the user selects an initial sequence or theme the “movie” starts or continues with the selected setting. The audience anytime throughout the viewing experience can change a chosen theme.

Input is obtained from the audience by way of a keypad, remote control, deck control, or other type of input device. In some cases input is not so much provided as it is sampled from the audience or based on pre-existing information. In one embodiment of the invention for instance one or more members of the audience are coupled to a biometric device or other type of sampling device configured to measure and obtain feedback from one or more audience members. Feedback may take the form of an audience member's heart rate, temperature, blood pressure, or any other type of feedback that can be sampled from an audience member. Once sampled this input is mapped to a hierarchy associated with a cumulative total of the input measurements in order to determine what storyline to follow. For instance, rather than prompting audience members for their voluntary feedback systems embodying one or more aspects of the invention may sample for biological feedback such as a heart rate and use the biological feedback information to determine what storyline is most appropriate. One storyline may be associated and played when one or more audience members are under or over a selected threshold level and another storyline can be played when audience measurements fall within a different threshold. The chosen storyline may in some cases be limited to one that is identified as having a particular theme. Hence an audience that opts to see a “horror” movie will be shown a storyline that stays within the selected theme. In cases where measurements taken from the audience indicate the audience is bored or not excited (e.g., heart rates are slow), the storyline may diverge to show the audience more exciting material. What is displayed is dictated by the input obtained from the audience. That input can be voluntary as in the case of a menu prompt that allows one or more audience member to make a selection or involuntary as in the case where one or more audience members are sampled for feedback based on innate biological characteristics.

The chosen storyline may also be dictated by other audience characteristics such as age, height, hair color, or other human variables. One storyline might be shown when audience members falls with a certain demographic profile and a different or slightly modified storyline can be shown when the interactive event is being viewed by a different demographic profile. An older audience, for instance, might be shown scenes that are left out for a younger audience and vis-versa. To collect demographic information about audience members one or more embodiments of the invention make use of a data collection interface configured to prompt audience members with specific questions about their demographics and/or personal preferences. This data collection interface may be a computer based interface, a web page or any other acceptable mechanism that allows users to input data in response to a set of presented questions. Once collected, information about each audience member is stored in a data repository such as a database and accessed whenever an audience member is identified as being present at an interactive event. This collected repository of audience information functions as input that influences or dictates what storyline is used during the interactive event. In one embodiment of the invention audience members are asked to sign-in or otherwise provide identifying information that allows the system to associate a particular audience member with the record for that audience member that is stored in the data repository. The data obtained from the audience members via the audience collection interface is then used to determine what storyline hierarchy to use in order to create the interactive event. An audience member's personal information and/or preferences may be used to determine what storyline to adopt and/or be used to set certain facts. A hero's birthday, for instance, may purposefully be modified to be the same as a particular audience member. If an audience member expresses a preference for a certain type of scene or theme the storyline may be adapted to include the preferred material.

In some cases it is not a single audience member who is able to impact the storyline, but the cumulative value of multiple audience members that dictates the storyline. In these cases the audience is given a cumulative value (e.g., an average, mean, median, or any other meaningful measurement) and that value is mapped to a particular storyline. When the cumulative value of the audience changes to a certain degree a different storyline is selected.

In one or more embodiments of the invention the storyline is selected by or influenced in part by outside environmental factors such as temperature, date, weather, or other measurable conditions. The storyline selected on a hot summer day may contain different scenes then are shown on a cold winter day. In other cases certain scenes or certain characters may be contained within the storyline when the interactive event takes place at or around a certain date such as Christmas, Halloween, or other holidays.

The process for implementing an interactive storyline differs from traditional movie making in that starting from the scripting the intention is to create multiple stories within a story where the audience influences the story that is to be made into an interactive event. Hence what factors or audience input is going to be allowed to influence the course of the story becomes an important part of the initial scripting. Instead of being a single story, different stories are scripted for different types of influencing input. Moreover audience members and not only the writer are invited to participate in decisions that must be made by characters in the film and/or provide other relevant input that might change the course of the storyline to traverse another path than it otherwise would have without the audience input. Hence each storyline is created in a way that allows for branching points where the branch that is selected during playback is dictated by audience input.

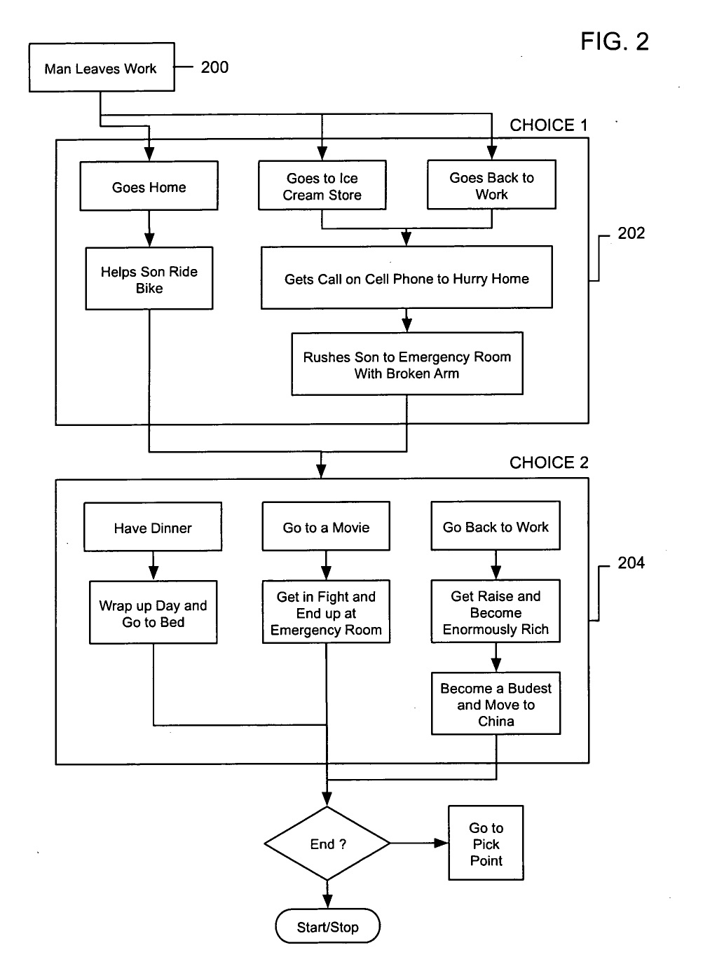

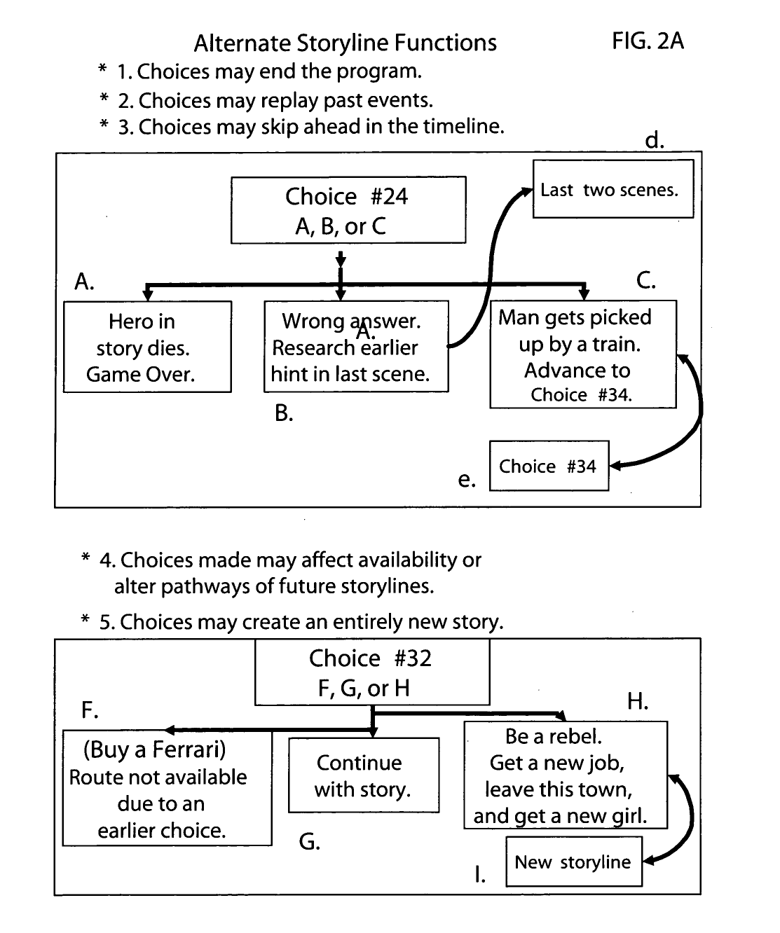

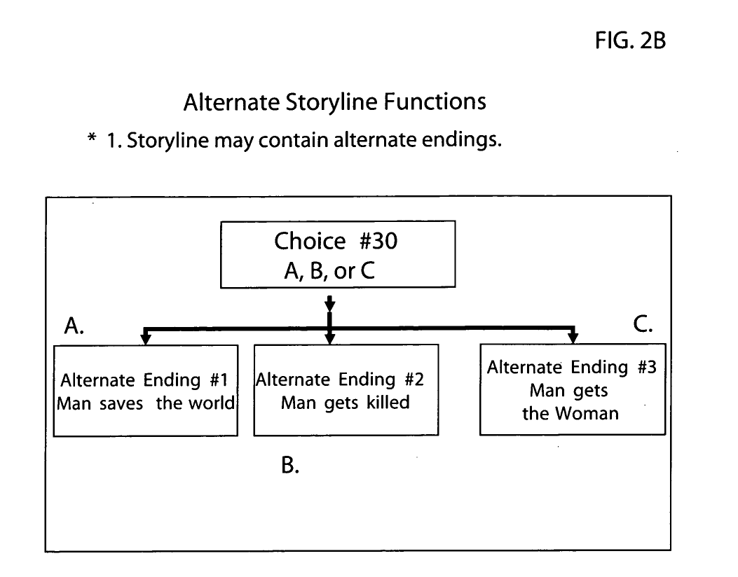

For instance, using this approach described herein a storyline will have multiple branching points and thereby enable viewers to participate in a different interactive event each time different inputs are given at a branch point. Hence a story might have 50 prompts and 150 storylines that stem from one main story. This means that based on the input provided the story may have alternate endings, dead ends, etc, (see FIG. 2). Note that this product is not limited to 50 prompts and 150 storylines, on the contrary, the design could yield many different re-arrangements and may include the notion of random seeding to change the storyline even when a same path is taken by the viewer on more than one occasion. Moreover values taken from the audience as input may be used as random seed values for the storyline.

FIG. 2 illustrates an example of an interactive storyline configured in accordance within an embodiment of the invention. As seen in the flow chart FIG. 2, (Block 200) Man leaves Work, Menu prompts viewer to select Choice 1 (202): (1a) Goes Home, (1b) Go to the Ice Cream Store, (1c) Go back to work. Each choice has an associated video clip result. In the example shown both (1b) and (1c) produce the same result of receiving a cell phone call to hurry home, while Choice (1a) results in a scene of the man teaching his son how to ride a bike. Choice (1b) or (1c) however, produce alternate stories. In making choice (1c) rather than (1b) the man was not at home and his son broke his arm thereby forcing the family to spend the evening at a hospital. In either case another branch point or choice is presented at Choice 2 (204) where the family can choose between (2a), (2b) or (2c). Hence based on the input received scenes of the man having dinner with his family (2a), the man going to a movie (2b) or the man going back to work (2c) are presented. Choice (2a) results in the man wrapping up the day and going to bed; choice (2b) results in the man getting in a fight and ending up in the emergency room. A scene or the outcome of a scene might be contingent upon audience input or on other outside environmental variables. Whether the man wins or looses the fight, for instance, could be contingent upon audience input or on other environmental factors. Choice (2c) results in the man getting a raise, becoming enormously wealthy and then moving to China to become a Buddhist monk. Again the specific scene can be selected by audience input or influenced by audience input as discussed above. The bottommost block in FIG. 2 yields the same end result now with two completely different stories. Audience members can back track or redo the interactive event by jumping to any one of the branch points (206).

Once the project is filmed or created in accordance with the various storylines, programming begins. This is accomplished by using a computer to programmatically enable the system to display different storylines based on different input at different branch points or other points in the storyline. For instance an author might use a computer configured to execute Sonic Scenarist, Spruce Compression, and other authoring software packages, standard definition Sony BVW monitors, Basic Computer Monitor, (6) 5.1 Dolby Surround Speakers, DLT drive, Pioneer DVD-R Burner, Adobe Photoshop, Adobe After Effects or other graphic programs. Practicing the invention is not limited to the use of any particular software program, but can be accomplished through the use of numerous different software packages and may also take advantage of custom built components configured to obtain the needed audience input and affect the storyline in view of that input.

In one or more embodiments of the invention one or more compression and authoring station is used to build the interactive event into a DVD project. Based on creative choice, as earlier explained, a certain portion of video may be played immediately followed by a static or animated menu screen that prompts the user to choose A, B, or C. A video clip that continues to tell a story based on the selection from the user immediately follows any of these choices. In one embodiment of the invention the programming for implementing the interactive event described herein is authored directly into the DVD project build, which can be stored on a DVD disc, DVD-ROM disc, DLT disc, the Internet, and other electronic portable devices. Other implementation are however feasible and contemplated as being within the scope and spirit of the invention.

FIG. 1a is a flow chart illustrating the overall concept of the interactive storyline. At block 1 the movie is shot on video and begins with a Man's decision to leave work and go home in block number one. At the end of the scene, the screen displays a “Choice Menu Screen” that allows the user to pick from the selection of actions. (see block # 2)
a. Man Goes Straight Home
b. Man goes to the Ice Cream Store before going home.
c. Man goes back to work.
   Based on the selection the user makes at block 2 of FIG. 1.1, the story rearranges the outcomes available. For example, since the Man chose to go to the Ice Cream store (block #3) before going home, he was not there to help his son ride his bicycle.

FIG. 2a illustrates the functionality provided by one or more embodiments of the invention by way of example. As one can determine from reviewing FIG. 2a choice made by the audience based on input may 1) end the program as seen in Choice A where the interactive event ends because the hero dies, 2) replay past events as depicted in Choice B that continues to block d. Because the input given by the audience resulted in the wrong answer the audience is replayed the previous two scenes and may again be prompted for the answer. Choices may skip ahead in the timeline as illustrated in Choice C continuing to block e which could for example jump forward in time or move to a different location in the storyline or show things from the perspective of a different character. For example, because the Man took the train, he advances to Choice #34. Choices made may affect availability or alter pathways in the future portion of the storyline. See for example the result of Choice F—Buy a Ferrari. This choice is not available due to an earlier decision, but could be made available if the correct sequence of input or decisions were made. Choices may create an entirely new story. See the result of Choice H—Be a rebel. Get a new job, leave this town, and get a new girl. Go to I.

The sequence of new settings allows the audience to create their own version of interactive event (e.g., “movie”) by varying the input provided, whether that input be provided in the form of voluntary decisions or made by other involuntary factors, environmental factors or other such input. For example audience members by providing input could elect for there to be 1.) Role reversal: the villain could be the hero, the hero could become the villain, 2) Plot reversal: the goal could be to steal a relic, but the audience could decide to protect it instead.

FIG. 2b illustrates the variability of storyline endings as performed in accordance with one or more embodiments of the invention. Referring to FIG. 2b for example, alternate endings may be displayed based on audience input and hence the storyline may have alternate endings. As seen in the results of Choices A, B, C, for example (a) Alt Ending 1: Man saves the World, (b) Alt Ending 2: Man gets killed, (c) Alt Ending 3: Man gets the Woman—(viewer wins as this is the goal of the storyline)

All three alternate endings may be available depending on earlier selections or input provided by the audience. An audience may be given a goal and rewarded for reaching the goal. The rewards may vary based on the deviation or lack of deviation in reaching the goal. Hence in one embodiment of the invention an audience might be asked to try and reach the correct ending with as little deviation as possible. To reach the goal the audience may encounter storylines that end, skip ahead, regress back or begin a new story altogether, etc. Rewards for reaching a goal may take many different forms and can, for instance grant audience members access to certain privileges (e.g., a movie premier or club membership, etc . . . ) or take the form of a product give always or discounts, cash rewards or other desirable rewards as dictated by a marketing plan or other promotional means. Audience specific information as collected via the data collection interface can influence or be used to help decide what reward is appropriate when an audience reaches a goal.

Hence a system and method for implementing an interactive storyline has been described by way of examples and illustrations set forth above. The claims however, and the full scope of their equivalents are what define the invention.

What is claimed is:

1. A computer program product comprising:
a computer usable memory medium having computer readable program code embodied therein where said computer readable program code is configured to:
obtain a storyline having associated video content from said computer usable memory medium where said storyline comprises references to a set of alternate video content;
display said video content in accordance with said storyline;
obtain input and provide said input to a selection interface comprising a set of branch points within said storyline where said set of branch points are associated with said references to said set of alternate video content;
obtain a selection corresponding to at least one of said set of branch points; and
display alternate video content from said set of alternate video content.

2. The computer program product of claim 1 wherein at least one of said set of branch points relates to a new storyline.

3. The computer program product of claim 1 wherein at least one of said set of branch points relates to a theme to be associated with said alternate video content.

4. The computer program product of claim 1 wherein said at least one of said set of branch points relates to a character in said storyline.

5. The computer program product of claim 1 wherein said display of said video content pauses during presentation of said selection interface.

6. The computer program product of claim 1 wherein said display of said video content continues during presentation of said selection interface.

7. The computer program product of claim 1 wherein said selection interface is presented during at least one predetermined point in said storyline.

8. The computer program product of claim 1 wherein said at least one predetermined point in said storyline is randomly selected during said display of said video content.

9. The computer program product of claim 1 wherein said at least one branch point continues said storyline.

10. The computer program product of claim 1 wherein said at least one branch point ends said storyline.

11. The computer program product of claim 1 wherein said at least one branch point replays past events in said storyline.

12. The computer program product of claim 1 wherein said at least one branch point converges to a different storyline.

13. The computer program product of claim 1 wherein said at least one branch point skips ahead in time on said storyline.

14. The computer program product of claim 1 wherein said branch points displayed in said selection interface depend on prior choices made.

15. The computer program product of claim 1 wherein said computer usable medium comprises a DVD.
